(19) United States
(12) Patent Application Publication
(10) Pub. No.: US 2023/0076875 A1
(43) Pub. Date: Mar. 9, 2023

(54) AVOIDING DATA PAGE UPDATES AFTER AN INSERTION OPERATION

(71) Applicant: International Business Machines Corporation, Armonk, NY (US)

(72) Inventors: Li Fei Zheng, Shanghai (CN); Di Jin, Beijing (CN); Min Fang, BEIJING (CN); JUN WAN, Beijing (CN); Po Lam Pauline Siu, Hong Kong (HK)

(21) Appl. No.: 17/466,012

(22) Filed: Sep. 3, 2021

(51) Int. Cl. G06F 16/22; G06F 16/23; G06F 16/27

(52) U.S. Cl. CPC G06F 16/2282; G06F 16/27; G06F 16/221; G06F 16/2379

(57) ABSTRACT

Computer technology where a data table and its index are created using a VOLATILE column type. Records are inserted with a final value and index is inserted with staging value. One bit is used in the data record header to indicate whether it is in-sync with its index. One bit in index key header indicates either this can be an index only update or needs to be a regular update. In the beginning, when a record is inserted into data page, both flag bits will be in the off status, meaning the data record is not in sync with its index entry and only index-only update(s) may be performed. This can prevent needless updates to a data page stored in a volatile memory (for example, a random access memory).

### BACKGROUND

The present invention relates generally to the field of updating and inserting data records into data pages.

### SUMMARY

According to an aspect of the present invention, there is a method, computer program product and/or system that performs the following operations (not necessarily in the following order): (i) storing a data table including a plurality of data records as a stored version of a database, with each row including a plurality of column values respectively corresponding to a plurality of columns; (ii) loading a first data page from the stored data table and into a random access memory (RAM) to obtain an in-memory copy of the first data page, with the first data page including data of N data records of the plurality of data records, where N is an integer of at least two; (iii) for each given row of the N data records of the first data page: (a) splitting a first column of the given data record into a first staging column and a first non-staging column, (b) storing a staging value in the first staging column of the given data record in the in-memory copy of the first data page, and (c) storing a non-staging value in the first non-staging column of the given data record in the in-memory copy of the first data page; and (iv) performing an insert operation on the in-memory copy, with the performance of the insert using the staging and non-staging values to prevent a page update with respect to the in-memory copy of the first data page.

According to an aspect of the present invention, there is a method, computer program product and/or system that performs the following operations (not necessarily in the following order): (i) storing a data table including a plurality of data records as a stored version of a database, with each data record including a plurality of field values respectively corresponding to a plurality of fields, with the plurality of fields including a first field; (ii) loading a first data page from the stored data table and into a random access memory (RAM) to obtain an in-memory copy of the first data page, with the first data page including data of N data records of the plurality of data records, where N is an integer of at least two; (iii) for each given data record of the N data records of the first data page: (a) splitting a first field of the given data record into a first staging field and a first non-staging field, (b) storing a staging value in the first staging field of the given data record in the in-memory copy of the first data page, and (c) storing a non-staging value in the first non-staging field of the given data record in the in-memory copy of the first data page; and (iv) performing an insert operation on the in-memory copy, with the performance of the insert using the staging and non-staging values to prevent a page update with respect to the in-memory copy of the first data page.

According to an aspect of the present invention, there is a method, computer program product and/or system that performs the following operations (not necessarily in the following order): (i) storing a data table including a plurality of data records as a stored version of a database, with each data record including a plurality of field values respectively corresponding to a plurality of fields, with the plurality of fields including a first field; (ii) loading a first data page from the stored data table and into a volatile memory (RAM) to obtain an in-memory copy of the first data page, with the first data page including data of N data records of the plurality of data records, where N is an integer of at least two; (iii) for each given data record of the N data records of the first data page: (a) splitting a first field of the given data record into a first staging field and a first non-staging field, (b) storing a staging value in the first staging field of the given data record in the in-memory copy of the first data page, and (c) storing a non-staging value in the first non-staging field of the given data record in the in-memory copy of the first data page; and (iv) performing an insert operation on the in-memory copy, with the performance of the insert using the staging and non-staging values to prevent a page update with respect to the in-memory copy of the first data page.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a screenshot view generated by the first embodiment system.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer’s non-volatile storage and partially stored in a set of semiconductor switches in the computer’s volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

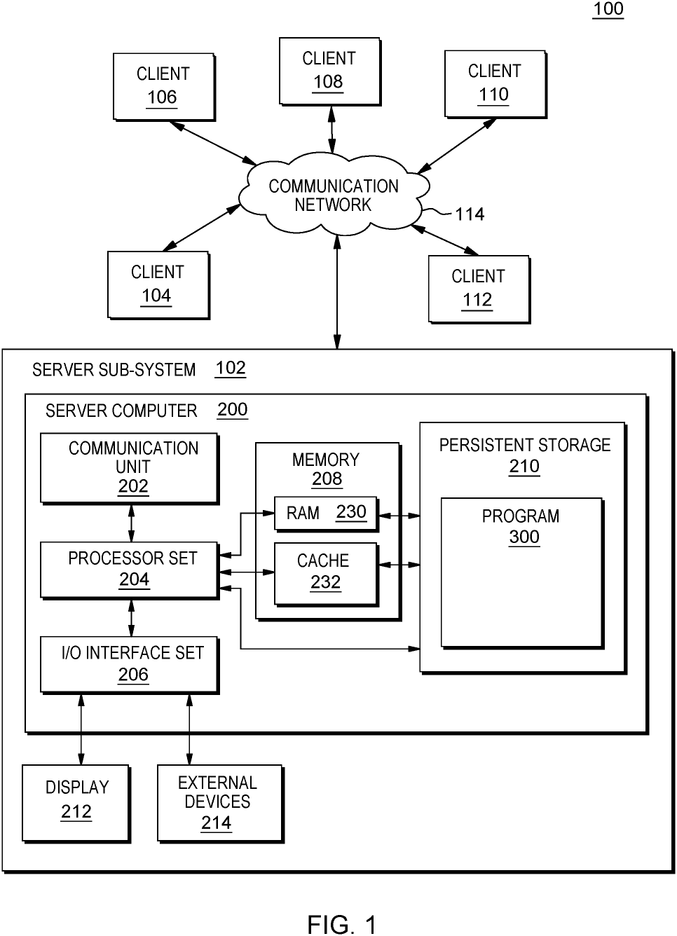

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

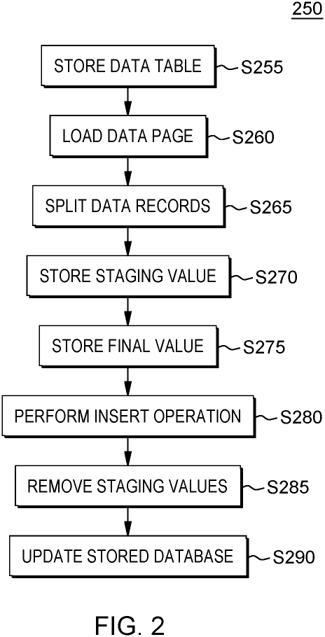

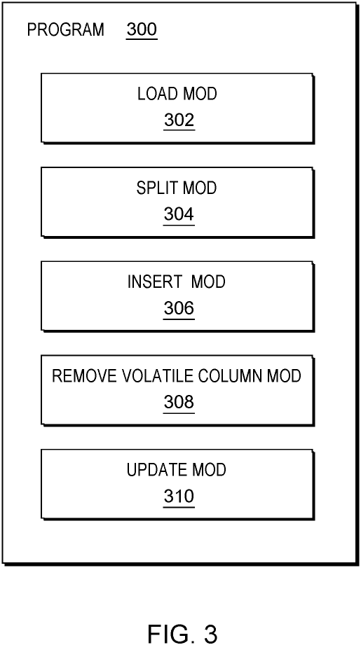

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

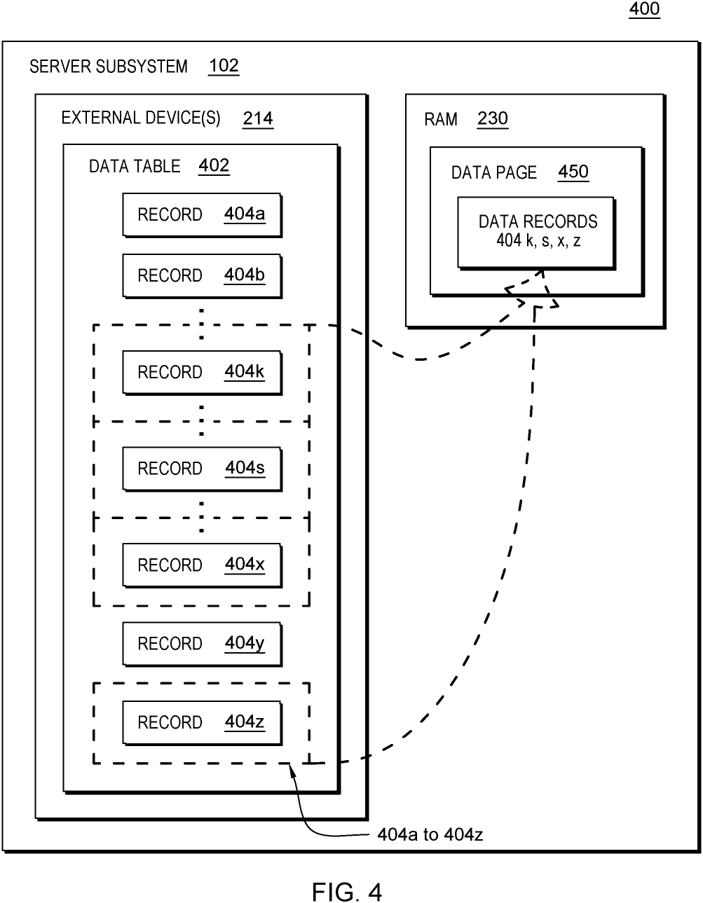

Processing begins at operation S255, where data table 402 is stored in external device(s) 215 of server subsystem 102, as shown in screenshot 400 of FIG. 4. Data table 402 includes a plurality of data records 404a to 404z. The stored version of a data table will sometimes herein be referred to a “database.” Each data record includes a plurality of field values (or column values) respectively corresponding to a plurality of fields (or columns).

Processing proceeds to operation S260, where load module (“mod”) 302 loads a data page unit amount: (i) from the stored version of data table 402 in external device(s) 214; and (ii) to RAM 230 as in-memory copy of data page 450 (also sometimes more simply herein referred to as data page 450). In this example, data page 450 includes the data (for example, field values) for four (4) data records of the plurality of data records, specifically data records 404k, 404s, 404x and 404z. In this example, the data page and its constituent records are being temporarily transferred, as a copy, to the RAM. The reason for this is that an insert operation is to be performed. The insert operation will first be performed on the copy in RAM before being implemented in the stored database. This is shown by dotted lines in FIG. 4.

Processing proceeds to operation S265, where split mod 304 splits at least one of the fields (or columns) of data records 404 k, s, x and z into: (i) a staging field (or column); and (ii) a non-staging field (or column). In this example, the non-staging field is a “final field” for final values only.

Processing proceeds to operation S270, where split mod 304 stores a staging value in the staging field of the data records 404 k, s, x and z in in-memory copy of the first data page 450.

Processing proceeds to operation S275, where split mod 304 stores a final value in the respective final fields of data records 404 k, s, x and z in data page 450.

Processing proceeds to operation S280, where insert mod 306 performs an insert operation on the in-memory copy of data page 450. This insertion uses the staging and final values to prevent a page update with respect to the in-memory copy of data page 450. More detailed information about this aspect of the present invention is set forth in the next sub-section of this Detailed Description section.

Processing proceeds to operation S285, where after the insert operation has fully completed, remove volatile column mod 308 removes the staging values from data records 404k, s, x and z of in-memory copy of data page 450. As will be further discussed in the next sub-section of this Detailed Description section, this is effectively the removal of a “volatile column.” The volatile column is only temporarily present in the RAM (that is, in the data page) so that the insert operation can proceed as efficiently and reliably as possible. At operation S285, this temporary, volatile column is no longer needed, so its associated column values are excised, and the column is effectively thereby removed.

Processing proceeds to S290, where update mod 310 updates the stored database to reintegrate the data of data records 404k, s, x and z (along with any new records that may be added by the insert operation) from: (i) the in-memory copy of the first data page; and (ii) back into data table 402 stored in external device(s) 214. Note: this operation S290 is not separately shown in FIG. 4.

### III. Further Comments and/or Embodiments

A relational database typically stores data in a table form. The table is made up of records, which are sometimes herein referred to as “rows.” For example, for a table that includes information about various individual people, each record may correspond to a different person, such that each person in the database will have exactly one row, no more and no less. Transactions that entail doing many insert operations, in order to insert new records into the data table, can lead to a situation where one of the insert operations simultaneously triggers another asynchronous thread to update the same record right after inserts. This simultaneous triggering of a second asynchronous thread in response to a single insert operation can lead to the following unfavorable consequences: (i) locking contention between insert and update when the asynchronous thread completes quickly; (ii) if the record is compressed, extra CPU (central processing unit) cost to decompress/compress the record during the update; and/or (iii) extra DASD (direct access storage device) space usage due to extra get page when the next insert fails for either of the following conditions: (a) conditional lock on the candidate page, or (b) if the updated record gets longer because of the update, then the record can cause overflow during decompress/compress operation(s).

For transactions doing heavy inserts and simultaneously triggering another asynchronous thread to update the same record right after inserts, the following conditions have been observed: (i) locking contention between insert and update when the asynchronous thread completes quickly; (ii) extra CPU cost to decompress/compress the record during the update if the record is compressed; and/or (iii) extra DASD space usage due to extra get page when the next insert failed on conditional lock on the candidate page or overflow record when decompress/compress if the updated record gets longer.

Consider a situation where a customer has this application which inserts a record to a table and triggers another asynchronous thread to send SMS (short message service) message to the account of the record. There’s one column of the table to show if SMS message is sent successfully. When the record is first inserted, its initial value is N. Later, when the asynchronous thread sends SMS message successfully, it will come back to update the column value from N to Y. What the customer observes is that there is contention between insert and update when the asynchronous thread completes quickly and when insert is still using the same page or when the insert hasn’t yet committed.

Some embodiments of the present invention may include one, or more, of the following features, characteristics, advantages and/or operations: (i) avoid data page update when a record is meant to be updated right after the insert; (ii) use of a new type of column (sometime herein referred to as “VOLATILE column(s)”) to be created with staging value(s) and a final value; (iii) this allows the index to be updated only without making an update to data record until the column is updated to have its final values (or any other non-staging values); and/or (iv) this enhancement facilitates data consistency, reduces contention and saves processor power by avoiding the data get page for locking and intermediate update (without making any change to customer’s application).

Some embodiments of the present invention may include one, or more, of the following features, characteristics, advantages and/or operations: (i) when the table and its index are created using this VOLATILE column type, the record is inserted with a final value and the index is inserted with a staging value; (ii) one bit is used in the data record header to indicate whether it is in-sync with its index; (iii) one bit in the index key header indicates either this can be an index only update or needs to be a regular update; (iv) in the beginning, when a record is inserted into the data page, both flag bits will be in off status, meaning the data record is not in sync with its index entry and only index-only update(s) may be performed; (v) UPDATEs can be done to this index only without the need to get the data page when the flag bit is off in the index key header; (vi) SELECTs can be done via this index, and even if they cannot, the actual value may still be obtained from this index whenever the flag bit is in off status in the data record header; (vii) until both flags are turned on, the database engine will process the update and select as normal; (viii) in data backup and recovery, COPY Table Space will always trigger a copy of the index involving this VOLATILE column type; and/or (ix) REBUILD INDEX then will invoke RECOVER INDEX to restore from the index copy and apply the associated database logs to make sure that there is no data loss.

Some embodiments introduce a new type of column to be created. and give an initial value and final value to the column as shown by the following example code:
CREATE TABLE T1.
(COLUMN 1 ACCOUNT NUMBER,
COLUMN 2 xxxxx,
COLUMN 3 XXX,
COLUMN X INITIAL VALUE N, FINAL VALUE Y).

When the record is inserted, it is inserted with a final value while the index is inserted with an initial value. Later, when a DBMS (database management system) detects that COLUMN is about to be updated to the final value. it just needs to update the index without making updates to the data page. Example code for such an update is as follows:

UPDATE TABLE T1 SET X = Y.

Some embodiments may include one, or more, of the following advantage(s): (i) avoids getting data page or lock the data page for update; and/or (ii) avoids getting or locking the data page is especially important in situations where the data page is compressed. This is because any update to the data page could cause even more problem(s), such as compress/decompress overhead and overflow records.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above - similar cautions apply to the term “embodiment.”

And/or: inclusive or; for example, A, B “and/or” C means that at least one of A or B or C is true and applicable.

Including / include / includes: unless otherwise explicitly noted, means “including but not necessarily limited to.”

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
storing a data table including a plurality of data records as a stored version of a database, with each row including a plurality of column values respectively corresponding to a plurality of columns;
loading a first data page from the stored data table and into a random access memory (RAM) to obtain an in-memory copy of the first data page, with the first data page including data of N data records of the plurality of data records, where N is an integer of at least two;
for each given row of the N data records of the first data page:
splitting a first column of the given data record into a first staging column and a first non-staging column,
storing a staging value in the first staging column of the given data record in the in-memory copy of the first data page, and
storing a non-staging value in the first non-staging column of the given data record in the in-memory copy of the first data page; and
performing an insert operation on the in-memory copy, with the performance of the insert using the staging and non-staging values to prevent a page update with respect to the in-memory copy of the first data page.

2. The CIM of claim 1 wherein the non-staging values are final values.

3. The CIM of claim 2 further comprising:
after the insert operation has fully completed, for each given row of the N rows of the in-memory copy of the first data page, removing the first staging value from the in-memory copy of the first data page.

4. The CIM of claim 3:
after removal of the first staging values, updating the stored database to re-integrate the first data page from the in-memory copy of the first data page.

5. The CIM of claim 1 wherein the CIM facilitates data consistency, reduces contention and saves processor power by avoiding a data get page for locking and intermediate update.

6. The CIM of claim 1 wherein:
one bit is used in a data record header to indicate whether a data record of the plurality of data records is in-sync with an index; and
one bit in index key header indicates one of the following: index only update or regular update.

7. A computer-implemented method (CIM) comprising:
storing a data table including a plurality of data records as a stored version of a database, with each data record including a plurality of field values respectively corresponding to a plurality of fields, with the plurality of fields including a first field;
loading a first data page from the stored data table and into a random access memory (RAM) to obtain an in-memory copy of the first data page, with the first data page including data of N data records of the plurality of data records, where N is an integer of at least two;
for each given data record of the N data records of the first data page:
splitting a first field of the given data record into a first staging field and a first non-staging field,
storing a staging value in the first staging field of the given data record in the in-memory copy of the first data page, and
storing a non-staging value in the first non-staging field of the given data record in the in-memory copy of the first data page; and
performing an insert operation on the in-memory copy, with the performance of the insert using the staging and non-staging values to prevent a page update with respect to the in-memory copy of the first data page.

8. The CIM of claim 7 wherein the non-staging values are final values.

9. The CIM of claim 8 further comprising:
after the insert operation has fully completed, for each given data record of the N data records of the in-memory copy of the first data page, removing the first staging value from the in-memory copy of the first data page.

10. The CIM of claim 9:
after removal of the first staging values, updating the stored database to re-integrate the first data page from the in-memory copy of the first data page.

11. The CIM of claim 7 wherein the CIM facilitates data consistency, reduces contention and saves processor power by avoiding a data get page for locking and intermediate update.

12. The CIM of claim 7 wherein:
one bit is used in a data record header to indicate whether a data record of the plurality of data records is in-sync with an index; and
one bit in index key header indicates one of the following: index only update or regular update.

13. A computer-implemented method (CIM) comprising:
storing a data table including a plurality of data records as a stored version of a database, with each data record including a plurality of field values respectively corresponding to a plurality of fields, with the plurality of fields including a first field;
loading a first data page from the stored data table and into a volatile memory (RAM) to obtain an in-memory copy of the first data page, with the first data page including data of N data records of the plurality of data records, where N is an integer of at least two;
for each given data record of the N data records of the first data page:
splitting a first field of the given data record into a first staging field and a first non-staging field,
storing a staging value in the first staging field of the given data record in the in-memory copy of the first data page, and
storing a non-staging value in the first non-staging field of the given data record in the in-memory copy of the first data page; and
performing an insert operation on the in-memory copy, with the performance of the insert using the staging and non-staging values to prevent a page update with respect to the in-memory copy of the first data page.

14. The CIM of claim 13 wherein the non-staging values are final values.

15. The CIM of claim 14 further comprising:
after the insert operation has fully completed, for each given data record of the N data records of the in-memory copy of the first data page, removing the first staging value from the in-memory copy of the first data page.

16. The CIM of claim 15:
after removal of the first staging values, updating the stored database to re-integrate the first data page from the in-memory copy of the first data page.

17. The CIM of claim 13 wherein the CIM facilitates data consistency, reduces contention and saves processor power by avoiding a data get page for locking and intermediate update.

18. The CIM of claim 13 wherein:
one bit is used in a data record header to indicate whether a data record of the plurality of data records is in-sync with an index; and
one bit in index key header indicates one of the following: index only update or regular update.
